(19) United States
(12) Patent Application Publication
(10) Pub. No.: US 2002/0129350 A1
(43) Pub. Date: Sep. 12, 2002

(54) Method of automatic software installation in hand personal computer production line

(75) Inventors: Ya-Hui Wang, Tienchin (CN); Jeff Song, Taipei (TW); Kuang-Hsin Lin, Taipei (TW)

Correspondence Address: BAKER & BOTTS, 30 ROCKEFELLER PLAZA, NEW YORK, NY, 10112

(73) Assignee: INVENTEC CORPORATION

(21) Appl. No.: 09/741,623

(22) Filed: Dec. 19, 2000

(51) Int. Cl. G06F 9/455

(52) U.S. Cl. 717/174

(57) ABSTRACT

Installation of software is forwarded by an automatic method in a Hand Personal Computer in the production line. The method includes defining setup executive files to store files and paths, which need to be copied. According to the defined data in the executive setup file, they are filled on a filelist. In the end, based on the filelist information, need-to-install software programs are copied into Hand Personal Computers.

### FIELD OF THE INVENTION

The present invention concerns automatic software installation, particularly to be used in the hand personal computer production line.

### BACKGROUND OF THE INVENTION

In Personal Computer manufacturing, at times, there should be a software installation procedure for products before being handed out to customers, for example, the installing of WinCE software in a Hand Personal Computer (HPC). Due to this, there is a desirable requirement for a simple and reliable software installation method, which can simplify the operation and reduce the potential error in a conventional way, to be utilized for the HPC in the production line.

According to the prior experience, the operation of software installation is mainly based on manual procedures. Every software program needs to be selected and to be saved to the target computer one by one in a manual operation. Therefore, by depending on these means of manual operation, the production is not effective.

In this conventional state, after finishing each piece of hand PC, the operators selects software programs one by one, and copy them from a Flash memory card through Management Information System (MIS) to a specific folder in the Hand PC.

For the present and even through the future of very large quantity computer production, there can be more error if the manual software installation procedure is repeated more often. Furthermore, this manual software installation procedure is not effective for production, and it is a waste of time and money. Yet with the proliferation of hand PC usage in production lines, it is desirable to include a simple and reliable software installation method.

### SUMMARY OF THE INVENTION

In accordance with the preferred embodiment of the present invention, automatic installation of software is forwarded by a management information system into a Hand Personal Computer. The present invention provides a designed program for software application program in production line for Hand Personal Computer System. The needed software programs can be installed into the just-manufactured HPCS in the production line by this designed program in the conventional method, it is was a waste to install the necessary application programs to HPC manually, and it is also easy to have manual errors.

It is therefore an objective of the present invention to provide a method in which a fast and convenient software installation is practiced in the PC production line. For example, software programs are selected one by one and put into the Information Resource Manager from an outside storage device such a flash card to be copied into specific folders of the Hand Personal Computer. However, as with the concept illustrated in the present invention, a setup executive file, such as auto.1st file of the preferred embodiment of the present invention, is defined to determine its data, then filling the information filelist by the data of the setup executive file to copy into an HPC.

In the accordance with the preferred embodiment of the present invention, in which the method consists of four main modulus ranges including: (1) Defining a setup executive file format for installation information, in which the file format can be default, and all information in the outside storage device can be copied into the Hand Personal Computer. (2) Defining need-to-copy file information, which is used for storing all need-to-copy files and their paths. (3) Filing the file information filelist by the content of the setup executive file. (4) Copying all of the files, which are stored in the filelist.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a flow chart for reading the setup executive file auto.1st preceding the automatic installation.

FIG. 2 shows a flow chart for preceding a record of auto.1 st.

FIG. 3 shows a flow chart of routinely read file information with match signals.

### DETAILED DESCRIPTION OF THE PREFERRED EMBODIMENT

Decrease the manual operation errors made by multi-selecting software programs for automatic software installation of Hand Personal Computer. By the present invention, the manual selecting operation can be reduced by using a filelist to contain all need-to-copy software program information, and then running a setup executive file to complete the software installation automatically.

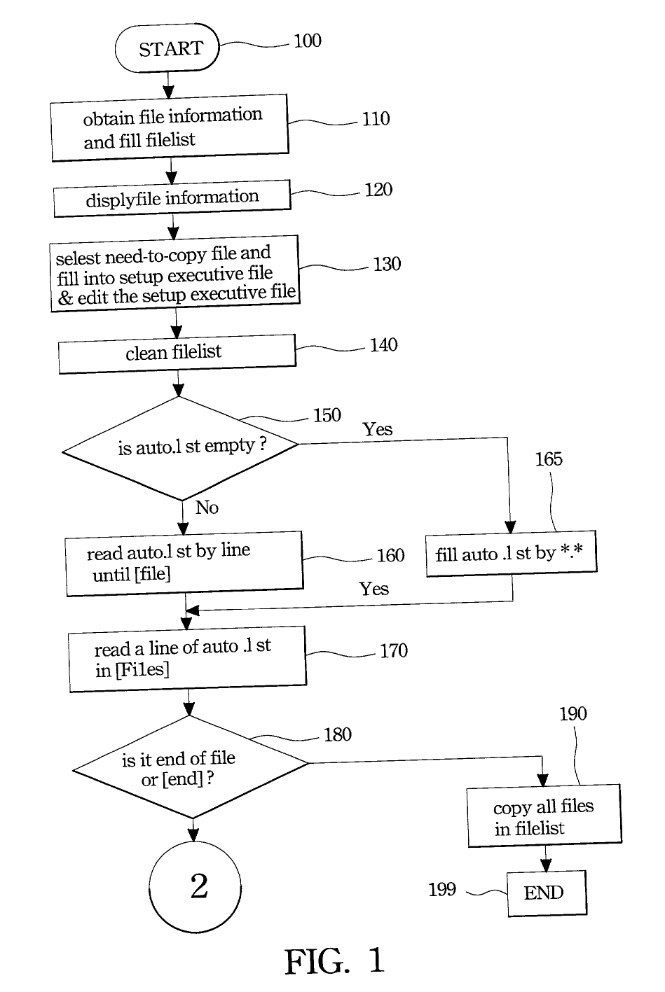

Referring now to FIG. 1, there is illustrated an embodiment of the procedure flowchart of automatic software installation. The main steps of the procedure are to fill need-to-copy software program files into an information list, and to execute the steps of auto.1st, in which the auto.1st file is defined as two parts: section name and section content. These two parts can be modified to change and/or extend the file programs for installation.

Take the example of copying the file in FIG. 1 in the following way, it can illustrate the content of auto.1 st:

[Files]

file section signal, and file information is stored wherein

File=format:

Including file name, file path

(The need-to-copy file name corresponds to the original path and match sign)

. . .

FileN= . . .

[End]

signal of end . . . it can be ignored

By changing the data of auto.1st, the need-to-copy application programs will also be changed as necessary in the production line. By removing the section name and section data in the auto.1 st, the name and path of those ready-install programs will also be removed, so this program will not be installed into a HPC system.

Similarly, by adding another section name and section data, the name and path of a new application program will also be-ready to be installed, so it will be installed in the HPC automatically, and the data it presents in auto.1st can be restricted as to a certain match condition, which is match sign.

With particular reference first to FIG. 1 and to the flowchart, all file data is obtained from an outside storage device, such as a flash logic chip, and then the data is filed into the Filelist, as described in Step 100. Next, in step 120, all filed data is shown in the Filelist on a displayer. For example, the displayer could be a computer monitor After that, a ready-to-install file is selected to fill in the setup executive file. Then, the setup executive file will be edited manually, so the selected file can be automatically filed into AUTO.1st, at which point the manual editing will be displayed. The filelist 140 will be clean once the editing is completed-for containing new information from the next step.

If the filelist is cleaned, the all paths of files in auto.1 st can be read. During the reading, it is necessary to decide whether it is the end of the filelist or not, and the result can be used for the basis for checking whether or not the auto.1 st is empty.

If the response is negative, it shows that there is installation information in the auto.1 st setup executive file, so the next step is to read the content of the auto.1 st setup executive file, block 160. In the preferred embodiment of the present invention, the reading manner is continuous until finding the [files], which means the information of the ready-install software application, so the finding of the [files] indicates the appearance of the information of the ready-install software application.

The following is a part of the example of editing auto.1st setup executive file in the present invention. Basically speaking, the content of the auto.1 st generally comprises:

[Files]

File1=readme.txt,\Setup

File2=Setup.exe,\Setup

File3=Hpc.exe,\Setup

File4=Pc\*. *,\Setup\Pc

[End]

The next step, referring to block 170, is to open the auto.1 st file and then read the content of the auto.1 st line by line. Once a line has been read, then to decide that this line is either the end or not. If the read line is the end of the file or the end of the section, such as [END] is read, all of the information of the ready-install software application in the setup executive file auto.1 st is then finished being read. Due to this, it is necessary to copy the information in Filelist from an outside storage device, block 170. The end, block 199, is the next after the copying finishes.

The following is the definition of copy file information on a filelist, which is described by an embodiment, for instance:

Structure Filelist
{
TCHAR = Filename [32]. . .Save file name
TCHAR = SrcFile[128]. . .Save the source file path
TCHAR = DesFile[128]. . .Save the destination file path
TCHAR = FileVer[16]. . .Save the file version number
Long size;. . . . .Save the file size
Filelist * next;. . . . .pointer indicates to the next data in the filelist
};

In block 150, if the response of checking the auto.1 st is positive, it shows that there is no limitation of installation information in the auto.1 st, so the next step is to fill the auto.1st file by “*.*”, which means all files are included. So, the entire content of the filelist needs to be installed. The step 170, reading a line of auto.1st file, proceeds right after filling, and then step 180 and the other steps are next.

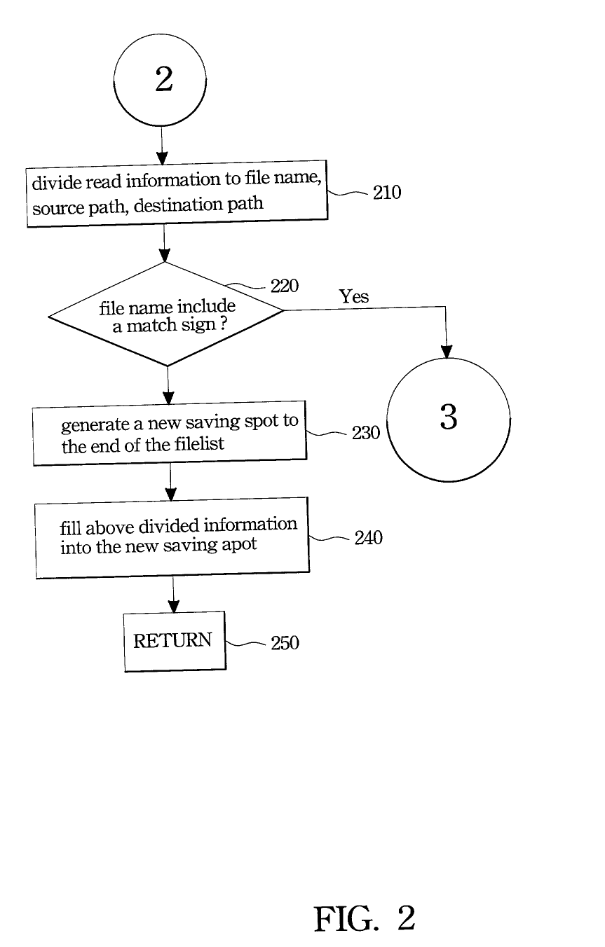

Therefore, if the result of block 180 is negative, it shows that the read line is not the section end or file end, so it comes to the next procedure: analyzing the read information to file the filelist, please referring to the FIG. 2.

FIG. 1 shows a preferred embodiment of the present invention, which analyzes the read information to fill the flowchart of the filelist. Before the Procedures in FIG. 2, it is focused on a general rough description of its reading of the auto.1st content line by line. From FIG. 2 on, it is focused on the method for reading [files]. Referring to block 210, dividing the read information of a line to FileName[ ], SrcPath[ ], DesPath[ ], and so on, where FileName is the representative need-to-copy file's name, SrcPath[ ] is the representative need-to-copy source file's path, and DesPath[ ] is the representative need-to-copy destination file's path.

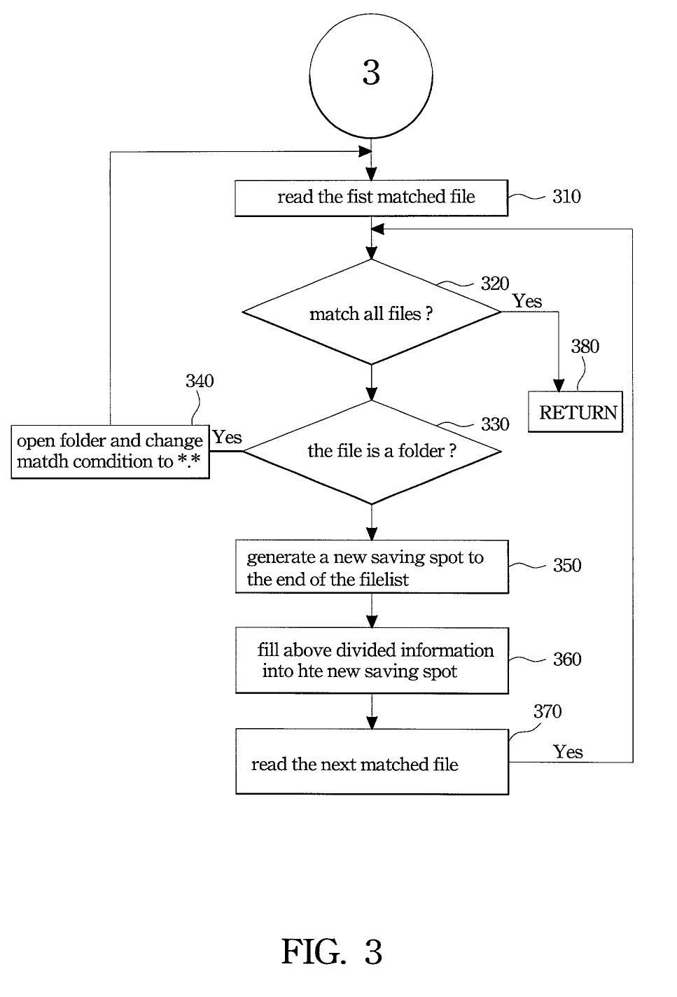

Once dividing and confirming that the read information contains a filename, the next step is to determine whether the filename has a match sign of not. Here, a match sign usually means a special symbol with a representative meaning. For example, “*.com”, “aut*.exe”, “au?*.*” etc., in which “?” represents 1 bit capacity of any number or sign, such as “A”, “2”, “h”; and “*” represent any sign without limiting its capacity as with “3F”, “exe”, “god36”. If the decision in step 220 is made as yes, which means it does contain these match signs in the filename, all documents that fit the match sign should be filled into the filelist, as shown in the FIG. 3 procedure below: routinely read all files which have match signs.

If the result in step 220 is that there is no match sign in the file name, the next step is not reading. Instead of reading, it is to generate a new list saving spot, block 230, and turn the next pointer of the original saving spot into the new saving spot. So, the saving spot is added to the end of the filelist, which means that the next work start is there. In step 240, the process of filing the just-read information, such as file name, source file path, destination file path, and so on, to the new start saving spot comprises the following steps: searching from the filelist to the start saving spot; deciding the goal path from the existing path. If it is not an existing path, it is necessary to create a new goal path; copying the source file registered in the source path to the appointed path; and indicating said duplicated file to the next saving spot in the filelist. After all of these steps are finished, it should be double-checked as to whether or not the filename has a match sign procedure until dealing with all saving spots.

The next step after filling is finished is to return to block 250, which is also to start from block 170 in the flowchart of the FIG. 1, and then execute and run the necessary steps.

As described in FIG. 3, in the embodiment of the present invention, it is procedure to routinely read all files with a match sign to fill a new saving spot in the filelist. Due to the prerequisite condition of this procedure as it is described in FIG. 2: there is a match sign in a file name, the prime and first step is to read the first file which fits in with the required condition, block 310. If the file is read, the next is to decide whether the file matches all conditions or not. If the answer is positive, which means matches all conditions, it can go to the next step, 380, Return. Please refer to block 170 in FIG. 1: reading a line from auto.1 st.

If the answer in step 320 is negative, which means it does not match all file conditions, it can not Return directly and needs to have a further step: checking as to whether it is a document folder or not, as in block 330.

If the answer in block 330 is negative, which means the reading material status is a single document, it can proceed with the work of generating a saving spot directly. However, if the answer is block 330 is positive, which means it is a document folder, it needs to add a step for Opening the folder. Also, it needs to change the match sign to *.* in order to make all documents in this folder fit within a readable condition range, so that all content in the folder can be read immediately thereafter. Since the match sign of the document in the folder has changed to *.*, the next step is to return to block 310 in FIG. 3: reading the document which fits in with conditions, and run the necessary procedure step by step.

On the other hand, if the answer in the block 330 is negative, which means this file is not a folder, it can be assumed that it is regarding a file used for software installation. The next step is in regard to increasing saving spots and filling them, which includes generating a filelist new saving spot 350, adding it to the end of the filelist, and filling newly read information, such as file name, source file path, and destination file path, to the newly generated saving spot. After filling the new saving spot, it reads the next file, which matches the conditions, block 370. In the same way as the description above, all of the procedures are run step by step. Until the end, all read files that match the condition then go to Return.

As in the description above, the important part of the present invention is about filling the copy file information to the filelist according to the content of auto.1st. According to the expression of the definition of the embodiment of auto.1st, the procedure includes reading the setup executive file data line by line until [End], and confirming that the data is from copy files.

First at all, the first line is read: File1=readme.txt,\Setup′ and a new saving spot of the Filelist is generated, turning the next pointer of the saving spot to the original saving spot.

The reading process is repeated as in the above description line by line until reading “Pc\*.*\Setup\Pc”, it will generate a new saving spot of the filelist here, and turn the next pointer of the new generated saving spot to the original spot. The read file information can be divided by means which include the source file path named “\Storage Card\Pc”, the start saving spot named SrcFile[ ], the destination file named “\Setup\Pc”, and the destination file path saving spot named DesFile[ ]. The next step is routinely to read all relative files and their subside files which fit in with the match sign and are filed into the Filelist. This kind of reading work goes repeatedly until the [End] is found.

The foregoing discussion discloses and describes merely the exemplary methods and the embodiment of the present invention. As will be understood by those familiar with the art, the invention may be embodied in other specific forms without departing from the spirit or essential characteristics thereof Accordingly, the disclosure of the present invention is intended to be illustrative, but not limiting the scope of the invention, which is set forth in the following claim.

What is claimed is:

1. A method for software installation to a Hand Personal Computer by managing a filelist system in the production line comprising the following steps:
(A) Producing a setup executive file for selecting software installation information for said Hand Personal Computer; and
(B) Running said setup executive file by said software installation information to produce the filelist, so the need-to install software can be copied to said Hand Personal Computer by corresponding to information saving spot defined in said filelist.

2. The method of claim 1, wherein in the steps of producing a setup executive file comprise further steps:
Obtaining all file information from an outside storage device, and filling said file information to said filelist;
Displaying all said file information to a user displayer of said filelist;
Selecting need-to-copy files;
Filling said need-to-copy files to said setup executive file;
Displaying and editing said setup executive files; and
Emptying said filelist.

3. The method of claim 2, wherein after displaying and editing said setup executive file comprises:
Reading said file installation information of said setup executive file if said setup executive file has said file installation information; and
Defining said setup executive file by selecting all file information from said outside storage device if said setup executive file does not have said file installation information.

4. The method of claim 1, wherein running said setup executive file comprises a further step:
Copying need-to-copy software to said Hand Personal Computer by said filelist if the reading is at the end of the line; and
Analyzing and filling the content of said read setup executive file to said filelist if the reading is not at the end of the line.

5. The method of claim 4, wherein analyzing the content of said read setup executive file comprises dividing said content of said read setup executive file to file name, source path and destination path line by line.

6. The method of claim 5 further comprising, after the step of analyzing the content of said read comprising following step:
Generating a new saving spot at the end of said filelist if said file name does not contain a match sign, as well as filling said file name, said source path, and said destination path to said saving spot.
Searching all files which fit in with the conditions, if said file name contains said match sign, and filing said file into said filelist.

7. The method of claim 6, wherein the step of searching all files which fit in with said conditions comprises the following steps:
If the first file fitting in with the match condition is a folder, opening said folder, and changing said match condition to selecting all documents; and
If the first file fits in with said match condition is not a folder, performing the following substeps:
Generating said new saving spot in said end of said filelist; and
Reading and filling said file name, said source path, and said destination path to said saving spot.

8. The method of claim 1, wherein the executive setup file comprises section names and section content.

9. The method as in claim 1, wherein the filelist is used for storing all need-to-copy files and their paths.

10. The method as in claim 1, wherein filelist comprises file name, source file path, destination file path, and pointer.

11. A computer readable medium which can be used for installing software programs to a Hand Personal Computer in the production line, comprising:
a setup executing unit which is used for selecting installation information of said software program for said Hand Personal Computer; and
an information list unit used for copying need-to-copy said software programs into said Hand Personal Computer by corresponding to an information saving spot in said information list.

12. The computer readable medium of claim 11, wherein said setup executing unit comprises said installation information, in accordance with its filling of said need-to-copy software information to said information list unit.

13. The computer readable medium as in claim 11, wherein setup executive unit comprise section name and section content.

14. The computer readable medium as in claims 11, wherein installation information comprises all need-to-copy files and their paths.

15. The computer readable medium as in claim 11, wherein installation information comprises file name, source file path, destination file path and pointer.
